(19) United States
(12) Patent Application Publication
(10) Pub. No.: US 2026/0172850 A1
(43) Pub. Date: Jun. 18, 2026

(54) MEASUREMENTS OPTIMIZATION TO REDUCE NUMBER OF MEASUREMENTS

(71) Applicant: Nokia Technologies Oy, Espoo (FI)

(72) Inventors: Lars DALSGAARD, Oulu (FI); Faranaz SABOURI-SICHANI, Aalborg (DK); Riikka Karoliina DIMNIK, Kirkkonummi (FI); Hans Thomas HÖHNE, Helsinki (FI); Jani-Pekka KAINULAINEN, Cottenham (GB)

(21) Appl. No.: 18/982,108

(22) Filed: Dec. 16, 2024

(51) Int. Cl. H04W 24/02; H04W 24/10

(52) U.S. Cl. CPC H04W 24/02; H04W 24/10

(57) ABSTRACT

A method, apparatus, and computer program product are provided. The method includes receiving, from a network node, a configuration defining a plurality of measurement types associated with carrier information that corresponds to a plurality of carrier groups. The method further includes determining one or more measurements associated with one or more carriers based on the carrier information that corresponds to the plurality of carrier groups, wherein the one or more measurements are to be performed on the one or more carriers belonging to the one or more measurement types of the plurality of measurement types based on user equipment preferences. The method further includes executing the one or more measurements associated with the one or more carriers based on the determination.

### TECHNOLOGICAL FIELD

An example embodiments relates generally to measurement optimization and, more particularly, to measurements optimization to reduce a number of measurements.

### BACKGROUND

A user equipment performs radio resource management (RRM) measurements on its serving cell or serving cells, as well as a list of inter-frequency and inter-radio access technology (RAT) carriers. The network is not required to provide the user equipment with any neighboring cell list. In a radio resource control (RRC) connected mode, the measurements may be used by the network. The network may use measurements for mobility management or for configuring one or more secondary cells (SCell) for carrier aggregation (CA) or a primary cell of secondary cell group (PSCell) for dual connectivity (DC), respectively.

In connected mode, the network configures the user equipment for measurements using a MeasConfig information element (IE) in a RRC reconfiguration message. The MeasConfig IE specifies which measurements to be performed by the user equipment, covering intra-frequency, inter-frequency, and inter-RAT mobility as well as configuration of measurement gaps.

A measObject configures which object (carriers) the user equipment shall measure. A reportConfig instructs the user equipment how the user equipment shall report any possible measurements to the network, for example, the rules and measurement quantities. Measurement procedures distinguish the following types of carriers and cells: (i) intra-frequency carriers and serving cells (the special cell (SpCell) and one or more SCells), (ii) inter-frequency carriers (carriers on which the user equipment has no serving cells), (iii) inter-RATR measurements (carriers not belonging to serving RAT (for example, LTE carriers), (iv) if configured, listed cells (cells listed within the measurement object(s)), and (v) if configured, detected cells (cells that are not listed within the measurement object(s) but are detected by the user equipment on the synchronization signal block (SSB) frequencies and subcarrier spacing(s) indicated by the measurement object(s)).

For new radio measurement objects, the user equipment measures and reports on the serving cell(s), any detected and measured non-serving cell, and if configured, listed cells and/or detected cells.

Based on network implementation, the user equipment may be configured with s-Measure, which is a serving cell reference signal received power (RSRP) threshold controlling whether the user equipment is required to perform measurements on non-serving cells. As long as the measured quantity (for example, RSRP) of the SpCell is above the configured threshold, the user equipment need not measure non-serving cells as it is considered that the user equipment has good radio conditions and does not need to measure on neighboring cells.

The network can configure the user equipment to report the measurement results periodically and/or based on configured events (event based). The measurement reporting events are configured by the network and may, for example, be triggered based on absolute value of measured received signal from serving cell(s) or neighboring cells and the relative offset between the measured values. The measurement reporting events which are relevant for this invention report are as follows: (i) event A1: serving becomes better than threshold, (ii) event A2: serving becomes worse than threshold, (iii) event A3: neighbor becomes offset better than SpCell, (iv) event A4: neighbor becomes better than threshold, (v) event A5: SpCell becomes worse than threshold1 and neighbor becomes better than threshold2, (vi) event A6: neighbor becomes offset better than SCell, (vii) event B1: inter-RAT neighbor becomes better than threshold, (viii) event B2: PCell becomes worse than threshold1 and inter-RAT neighbor becomes better than threshold2.

Irrespective of an event which triggers a report, a measurement report includes all available measurement on a serving cell and includes measured cells on the carrier triggering the report and other carriers as configured in measurement reporting configuration. Besides usage of measurement for mobility purpose, the network node may use the reported measurement results to configure and/or add SCells. For example, a network node may use A1, A4, or another measurement report event trigger to configure CA with a selected SCell to add among the reported cells. Once an SCell is added to the set of serving cells (PCell and one or more SCells), it becomes a serving cell, and the user equipment performs intra-frequency measurements on the SCell (as on all the serving cells). The most common case is that the user equipment can perform such without a need for measurement gaps (but it is ultimately up to network configuration).

Furthermore, the network node may aim at configuring the user equipment with a best cell on a given carrier as SCell. To do this, the network node would benefit from user equipment measurement reports. Hence, selecting the best cell on a carrier is more likely possible if the user equipment detects and reports the best cell(s) on the concerned SCell's carrier frequency (this either being a carrier on which there is an SCell configured or an inter-frequency carrier). For example, the purpose of maintaining SCell being the best cell on the carrier, the network can use a measurement report triggered by an A6 event which is intended for intra-frequency measurement events on SCell's carrier frequencies.

Another usage of measurement reports is for dual connectivity, where there is a need to add a second RRC connection. In that case, an A4 measurement report is used to select a PSCell to configure NRDC.

### BRIEF SUMMARY

In one or more embodiments, a user equipment (120) for wireless communication, is provided, including at least one processor and at least one memory storing instructions thereon that, when executed by the at least one processor, cause the user equipment (120) to receive (302), from a network node (112), a configuration (302a) defining a plurality of measurement types associated with carrier information (302b) that corresponds to a plurality of carrier groups. The user equipment (120) is further caused to determine (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The user equipment (120) is further caused to execute the one or more measurements associated with the one or more carriers based on the determination.

In one or more embodiments, a user equipment (120) is provided for wireless communication, including means for receiving (302), from a network node (112), a configuration (302a) defining a plurality of measurement types associated with carrier information (302b) that corresponds to a plurality of carrier groups. The user equipment (120) further includes means for determining (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The user equipment (120) further includes means for executing the one or more measurements associated with the one or more carriers based on the determination.

In one or more embodiments, a computer-implemented method, performed by a user equipment (120), is provided, including receiving (302), from a network node (112), a configuration (302a) defining a plurality of measurement types associated with carrier information (302b) that corresponds to a plurality of carrier groups. The method further includes determining (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The method further includes executing the one or more measurements associated with the one or more carriers based on the determination.

In one or more embodiments, a non-transitory computer readable storage medium is provided including computer instructions that, when executed by a user equipment, cause the user equipment to receive (302), from a network node (112), a configuration (302a) defining a plurality of measurement types associated with carrier information (302b) that corresponds to a plurality of carrier groups. The user equipment (120) is further caused to determine (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The user equipment (120) is further caused to execute the one or more measurements associated with the one or more carriers based on the determination.

A user equipment (120) for wireless communication is provided, including at least one processor and at least one memory storing instructions thereon that, when executed by the at least one processor, cause the user equipment (120) to receive (302), from a network node (112), a configuration (302a) defining a plurality of measurement types associated with carrier information (302b) that corresponds to one or more carriers. The user equipment is further caused to receive (402) an indication (304) from the network node (112) to indicate which of the one or more carriers that corresponds to one or more measurement types of the plurality of measurement types are to be measured. The user equipment (120) is further caused to execute (404) measurements, on the one or more carriers that corresponds to the one or more measurement types of the plurality of measurement types, according to the received indication.

In one or more embodiments, a network node (112) for wireless communication, is provided, including at least one processor and at least one memory storing instructions thereon that, when executed by the at least one processor, cause the network node (112) to transmit (302), to a user equipment (120), a configuration (302a) defining a plurality of measurement types associated with carrier information (302b) that corresponds to one or more carriers. The network node is further caused to transmit (502) an indication (304) to indicate to the user equipment (120) which of the one or more carriers that corresponds to one or more measurement types of the plurality of measurement types.

In one or more embodiments, a user equipment (120) is provided, including means for receiving (302, 402), from a network node (112), a configuration (302a) defining a plurality of measurement types associated with carrier information (302b) that corresponds to one or more carriers. The user equipment (120) further includes means for receiving (402) an indication (304) from the network node (112) to indicate which of the one or more carriers that corresponds to one or more measurement types of the plurality of measurement types are to be measured. The user equipment further includes means for executing (404) measurements, on the one or more carriers that corresponds to the one or more measurement types of the plurality of measurement types, according to the received indication.

In one or more embodiments, a network node (112) is provided, including means for transmitting (302, 502), to a user equipment (120), a configuration (302a) defining a plurality of measurement types associated with carrier information (302b) that corresponds to one or more carriers. The network node further includes means for transmitting (502) to the user equipment (120), an indication (304) to indicate to the user equipment (120) which of the one or more carriers that corresponds to one or more measurement types of the plurality of measurement types.

In one or more embodiments, a computer-implemented method is provided, performed by a user equipment (120), including receiving (302, 402), from a network node (112), a configuration (302a) defining a plurality of measurement types associated with carrier information (302b) that corresponds to one or more carriers. The method further includes receiving (402) an indication (304) from the network node (112) to indicate which of the one or more carriers that corresponds to one or more measurement types of the plurality of measurement types are to be measured. The method further includes executing (404) measurements, on the one or more carriers that corresponds to the one or more measurement types of the plurality of measurement types, according to the received indication.

In one or more embodiments, a computer-implemented method is provided, performed by a network node (112), including transmitting (302, 502), to a user equipment (120), a configuration (302a) defining a plurality of measurement types associated with carrier information (302b) that corresponds to one or more carriers. The method further includes transmitting (502) an indication (304) to indicate to the user equipment (120) which of the one or more carriers that corresponds to one or more measurement types of the plurality of measurement types.

In one or more embodiments, a non-transitory computer readable storage medium is provided including computer instructions that, when executed by a user equipment, cause the user equipment to receive (302, 402), from a network node (112), a configuration (302a) defining a plurality of measurement types associated with carrier information (302b) that corresponds to one or more carriers. The user equipment (120) is further caused to receive (402) an indication (304) from the network node (112) to indicate which of the one or more carriers that corresponds to one or more measurement types of the plurality of measurement types are to be measured. The user equipment is further caused to execute (404) measurements, on the one or more carriers that corresponds to the one or more measurement types of the plurality of measurement types, according to the received indication.

In one or more embodiments, a non-transitory computer readable storage medium is provided including computer instructions that, when executed by a network node, cause the network node to transmit (302, 502), to a user equipment (120), a configuration (302a) defining a plurality of measurement types associated with carrier information (302b) that corresponds to one or more carriers. The network node is further caused to transmit (502) an indication (304) to indicate to the user equipment (120) which of the one or more carriers that corresponds to one or more measurement types of the plurality of measurement types.

In one or more embodiments, a user equipment (120) for wireless communication is provided, including at least one processor and at least one memory storing instructions thereon that, when executed by the at least one processor, cause the user equipment (120) to receive (302, 602), from a network node (112), a configuration (302a) defining a plurality of measurement types associated with carrier information (302b) that corresponds to a plurality of carrier groups. The user equipment is further caused to receive (602), from the network node (112) an indication (304) that the user equipment (120) shall determine one or more measurement types of the plurality of measurement types. The user equipment (120) is further caused to determine (306, 604), based on the indication (304), one or more measurements associated with one or more carriers based on the carrier information (302b) that corresponds to the plurality of carrier groups, wherein the one or more measurements are to be performed on the one or more carriers belonging to the one or more measurement types of the plurality of measurement types. The user equipment (120) is further caused to execute (606) the one or more measurements associated with the one or more carriers based on the determination.

In one or more embodiments, a network node (112) for wireless communication is provided, including at least one processor and at least one memory storing instructions thereon that, when executed by the at least one processor, cause the network node (112) to transmit (302, 702), to a user equipment (120), a configuration (302a) defining a plurality of measurement types associated with carrier information (302b) that corresponds to a plurality of carrier groups and comprising an indication (304) that the user equipment (120) shall determine (306) one or more measurement types of the plurality of measurement types. The network node (112) is further caused to transmit (702) to the user equipment (120) an indication (304) that the user equipment (120) shall determine (306) one or more measurement types of the plurality of measurement types.

In one or more embodiments, a user equipment (120) for wireless communication is provided, including means for receiving (302, 602), from a network node (112), a configuration (302a) defining a plurality of measurement types associated with carrier information (302b) that corresponds to a plurality of carrier groups. The user equipment further includes means for receiving (602), from the network node (112) an indication (304) that the user equipment (120) shall determine one or more measurement types of the plurality of measurement types. The user equipment (120) further includes means for determining (306, 604), based on the indication (304, one or more measurements associated with one or more carriers based on the carrier information (302b) that corresponds to the plurality of carrier groups, wherein the one or more measurements are to be performed on the one or more carriers belonging to the one or more measurement types of the plurality of measurement types. The user equipment (120) further includes means for executing (606) the one or more measurements associated with the one or more carriers based on the determination.

In one or more embodiments, a network node (112) for wireless communication is provided, including means for transmitting (302, 702), to a user equipment (120), a configuration (302a) defining a plurality of measurement types associated with carrier information (302b) that corresponds to a plurality of carrier groups and comprising an indication (304) that the user equipment (120) shall determine (306) one or more measurement types of the plurality of measurement types. The network node (112) further includes means for transmitting (702) to the user equipment (120) an indication (304) that the user equipment (120) shall determine (306) one or more measurement types of the plurality of measurement types.

In one or more embodiments, a computer-implemented method, performed by a user equipment (120), is provided, including receiving (302, 602), from a network node (112), a configuration (302a) defining a plurality of measurement types associated with carrier information (302b) that corresponds to a plurality of carrier groups. The method further includes receiving (602), from the network node (112) an indication (304) that the user equipment (120) shall determine one or more measurement types of the plurality of measurement types. The method further includes determining (306, 604), based on the indication (304), one or more measurements associated with one or more carriers based on the carrier information (302b) that corresponds to the plurality of carrier groups, wherein the one or more measurements are to be performed on the one or more carriers belonging to the one or more measurement types of the plurality of measurement types. The method further includes executing (606) the one or more measurements associated with the one or more carriers based on the determination.

In one or more embodiments, a computer-implemented method, performed by a network node (112), is provided including transmitting (302, 702), to a user equipment (120), a configuration (302a) defining a plurality of measurement types associated with carrier information (302b) that corresponds to a plurality of carrier groups and comprising an indication (304) that the user equipment (120) shall determine (306) one or more measurement types of the plurality of measurement types. The method further includes transmitting (702) to the user equipment (120) an indication (304) that the user equipment (120) shall determine (306) one or more measurement types of the plurality of measurement types.

In one or more embodiments, a non-transitory computer readable storage medium is provided including computer instructions that, when executed by a user equipment, cause the user equipment to receive (302, 602), from a network node (112), a configuration (302a) defining a plurality of measurement types associated with carrier information (302b) that corresponds to a plurality of carrier groups. The user equipment is further caused to receive (602), from the network node (112) an indication (304) that the user equipment (120) shall determine one or more measurement types of the plurality of measurement types. The user equipment (120) is further caused to determine (306, 604), based on the indication (304), one or more measurements associated with one or more carriers based on the carrier information (302b) that corresponds to the plurality of carrier groups, wherein the one or more measurements are to be performed on the one or more carriers belonging to the one or more measurement types of the plurality of measurement types. The user equipment (120) is further caused to execute (606) the one or more measurements associated with the one or more carriers based on the determination.

In one or more embodiments, a non-transitory computer readable storage medium is provided including computer instructions that, when executed by a network node, cause the network node to transmit (302, 702), to a user equipment (120), a configuration (302a) defining a plurality of measurement types associated with carrier information (302b) that corresponds to a plurality of carrier groups and comprising an indication (304) that the user equipment (120) shall determine (306) one or more measurement types of the plurality of measurement types. The network node (112) is further caused to transmit (702) to the user equipment (120) an indication (304) that the user equipment (120) shall determine (306) one or more measurement types of the plurality of measurement types.

### BRIEF DESCRIPTION OF THE DRAWINGS

Having thus described certain example embodiments of the present disclosure in general terms, reference will hereinafter be made to the accompanying drawings, which are not necessarily drawn to scale, and where:

FIG. 1 is a communication network to which example embodiments disclosed herein may be applied;

FIG. 2 illustrates a communications device that may include various components configured to perform operations for the techniques disclosed herein in accordance with aspects of the present disclosure;

FIG. 3 illustrates a signaling diagram of a method to optimize and reduce the number of inter-frequency and inter-RAT measurements at a user equipment without a need to change measurement configuration frequently or too often in accordance with example embodiments of the present disclosure;

FIG. 4 illustrates a flowchart for a process performed by a user equipment in order to transmit a measurement report based on network preferences in accordance with example embodiments of the present disclosure;

FIG. 5 illustrates a flowchart for a process performed by a network node in order to receive a measurement report based on network preferences in accordance with example embodiments of the present disclosure;

FIG. 6 illustrates a flowchart for a process performed by a user equipment in order to transmit a measurement report based on a network indication that the user equipment should determine one or more measurements in accordance with example embodiments of the present disclosure;

FIG. 7 illustrates a flowchart for a process performed by a network node in order to receive a measurement report based on network preferences in accordance with example embodiments of the present disclosure;

FIG. 8 illustrates a flowchart for a process performed by a user equipment in order to transmit a measurement report based on user equipment preferences in accordance with example embodiments of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Embodiments described may be implemented in a communication network, such as any of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communication within the communication network may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

As used herein, the term “network device” or “network node” refers to a node in a communication network via which user equipment may access the network and/or which is capable of controlling radio communication and managing radio resources within a cell. The network node or network device may be referred to as a base station (BS), an access point (AP) or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device such as a satellite network device, a low earth orbit (LEO) satellite and a geosynchronous earth orbit (GEO) satellite, or an aircraft network device.

Moreover, in connection of split radio access network (RAN), the network device may refer to a centralized unit (CU) of a base station and/or a distributed unit (DU) of a base station. An interface between CU and DU may be referred to as an F1 interface in NR. In the split RAN architecture, node operations may be carried out, at least partly, in the central/centralized unit, CU, (e.g. server, host or node) operationally coupled to the DU, (e.g. a radio head/node). One CU may control one or more DUs, acting at least as transmit/receive (Tx/Rx) nodes. In some embodiments, the DUs may comprise e.g. a radio link control (RLC), medium access control (MAC) layer and a physical (PHY) layer, whereas the CU may comprise the layers above RLC layer, such as a packet data convergence protocol (PDCP) layer, a radio resource control (RRC) and an internet protocol (IP) layers. Other functional splits are possible too. In practice, any processing task may be performed in either the CU or the DU and the boundary where the responsibility is shifted between the CU and the DU may depend on the applied implementation.

The term “terminal device” refers to any end device that may be capable of wireless communication. By way of example, a terminal device may be referred to as a communication device, user equipment (UE), a Subscriber Station (SS), or a Mobile Station (MS). The terminal device may include a mobile phone, a cellular phone, a smart phone, voice over IP (VoIP) phones, wireless local loop phones a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources include e.g. a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

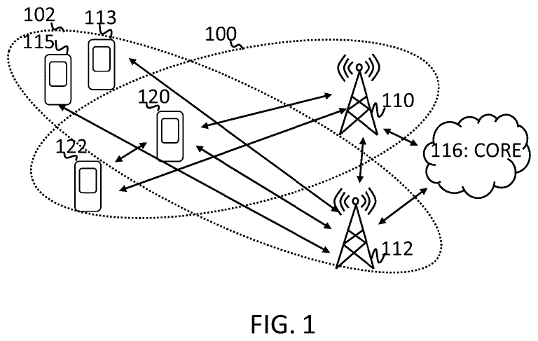

FIG. 1 illustrates an example of a communication network to which examples disclosed herein may be applied. The communication network or a cellular communication network may comprise a network node 110 providing one or more cells, such as cell 100, and a network node 112 providing one or more other cells, such as cell 102. Each cell may be, e.g., a macro cell, a micro cell, femto, or a pico cell, for example. The cell may define a coverage area or a service area of the corresponding access node.

The network node 110 may provide a user equipment (UE) 120 (one or more UEs) with wireless access to the communication network. The wireless access may comprise downlink (DL) communication from the network node to the UE 120 and uplink (UL) communication from the UE 120 to the network node. Examples of uplink channels comprise physical uplink control channel (PUCCH) for transmitting control information and physical uplink shared channel (PUSCH) for transmitting data towards the network. Examples of downlink channels comprise physical downlink control channel (PDCCH) for transmitting control information and physical downlink shared channel (PDSCH) for transmitting data towards the user equipment.

There may be a plurality of UEs 120, 122, 113, 115 in the system. Each of them may be served by the same or by different network nodes 110, 112. UE may be configured with dual connectivity (DC), wherein the UE, e.g. UE 120, may be connected to multiple network nodes 110, 112. The UEs 120, 122 may communicate with each other, in case device-to-device (D2D) communication interface is established between them via a so-called sidelink (SL). Such D2D communications may be referred to as machine-to-machine, peer-to-peer (P2P) communications, or vehicle-to-vehicle (V2V), for example.

In the case of multiple network nodes in the communication network, the network nodes may be connected to each other via an interface. LTE specifications call such an interface as X2 interface. An interface between an LTE node and a 5G node, or between two 5G nodes may be called Xn interface.

The network nodes 110 and 112 may be further connected via another interface to a core network 116 of the communication network. The LTE specifications specify the core network as an evolved packet core (EPC), and the core network may comprise e.g. a mobility management entity (MME) and a gateway node. The MME may handle mobility of terminal devices in a tracking area encompassing a plurality of cells and handle signaling connections between the terminal devices and the core network. The gateway node may handle data routing in the core network and to/from the terminal devices. The 5G specifications specify the core network as a 5G core (5GC). The 5G core may comprise e.g. an access and mobility management function (AMF) and a user plane function/gateway (UPF) and other functions. The AMF may handle termination of non-access stratum (NAS) signaling, NAS ciphering & integrity protection, registration management, connection management, mobility management, access authentication and authorization, security context management. The UPF node may support packet routing and forwarding, packet inspection and quality of service (QoS) handling, for example.

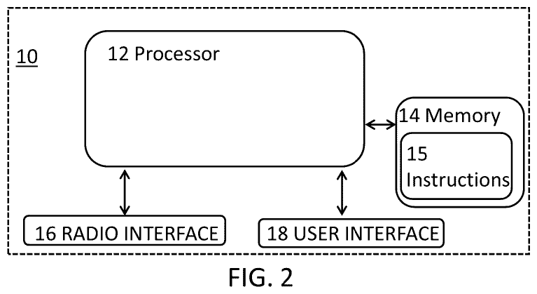

FIG. 2 shows, by way of example, a block diagram of an apparatus 10. The apparatus 10 comprises, for example, at least one processor 12 and at least one memory 14 storing instructions 15 that, when executed by the at least one processor, cause the apparatus 10 at least to perform the method or methods as disclosed herein, and any of the embodiments thereof. In an example, the at least one memory and the instructions (e.g. a computer program code, software), are configured, with the at least one processor, to cause the apparatus 10 to perform the method or methods as disclosed herein, and any of the embodiments thereof.

A processor 12 may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may be at least in part external to apparatus 10 but accessible to apparatus 10.

The instructions 15 may be comprised in a computer readable medium or a non-transitory computer readable medium. A term non-transitory, as used herein, is a limitation of the medium itself (i.e. tangible, not a signal) as opposed to a limitation on data storage persistency (e.g. random access memory, RAM, vs. read only memory, ROM).

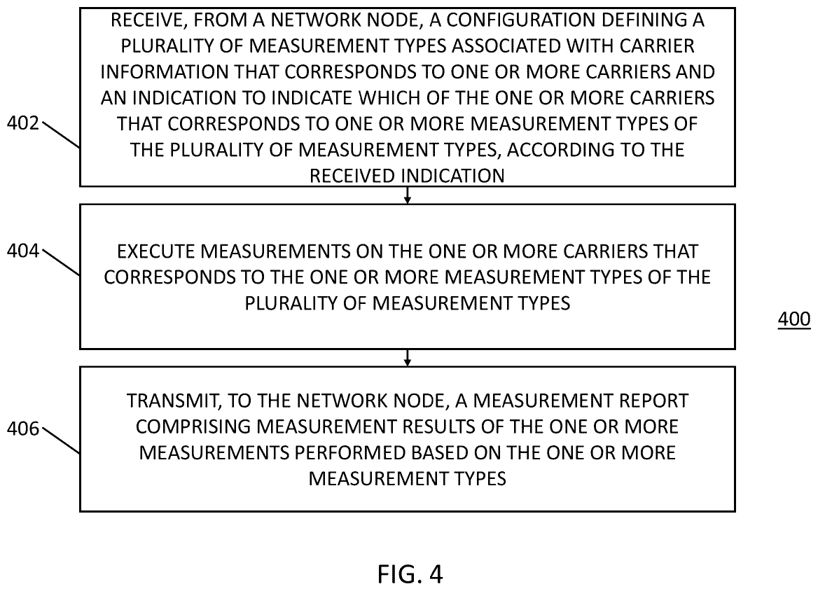

For example, the apparatus 10 is a terminal device, such as the UE of FIG. 1. As another example, the apparatus is comprised in such a terminal device, e.g. as a chipset configured to control the terminal device. The apparatus 10 may be caused or configured to perform at least the method of FIGS. 4-8 and/or any one or more of the embodiments described.

As another example, the apparatus 10 is a network node, e.g. the network node of FIG. 1. In another embodiment, the apparatus is comprised in such a network node, e.g. as a chipset configured to control the network node. The apparatus 10 may be caused or configured to perform at least the method of FIGS. 4-8 and/or any one or more of the embodiments described.

The apparatus may comprise one or more entities of any of protocol layers, such as a MAC entity, an RRC entity, an RLC entity, a PDCP entity or a PHY entity. In some embodiments, the entity is configured to perform at least the method of FIGS. 10-13, and/or any one or more of the embodiments described.

The apparatus 10 comprises a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 10 may comprise a user interface 18 comprising, for example, at least one of a keypad, a microphone, a touch display, a display, a speaker, etc. The user interface 18 may be used to control the apparatus by the user. The user interface 18 may be external to the apparatus 10. For example, the apparatus 10 may be connected to another device, such as a computer, either via wireless or wired connection, and the apparatus 10 is controlled by the user via the computer.

In an embodiment, at least some of the processes described herein may be carried out by an apparatus comprising means for carrying out at least some of the described processes. Means for performing method steps as disclosed herein may include software and/or hardware components of the apparatus 10. For example, the at least one processor 12, the memory 14, and the computer program code form means for carrying out the method or methods as disclosed herein, and any of the embodiments thereof. As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Unless configured otherwise, the user equipment continually measures all serving cells to ensure that the user equipment is connected to the best cell and does not drop from service (due to, for example, moving outside the cell coverage). In addition, the user equipment shall keep monitoring the radio link condition to evaluate its connection to its primary serving cell(s) and the quality of the link.

A user equipment is configured by the network with carriers that the network wants the user equipment to measure. A user equipment searches and measures carriers without a need for providing cell list information. The network may also configure the user equipment with a list of cells (e.g., non-serving (neighboring) intra-frequency, inter-frequency, and inter-RAT cells).

Measurement results may be used to configure or add SCells for carrier aggregation or a PSCell for dual connectivity. Intra-frequency measurements would, in the common scenario, not be measurement gap assisted. Hence, intra-frequency measurements can be performed by a user equipment without introducing network implementation complexity and limitation in scheduling, or separate power-up/power-down or re-tuning of a user equipment's reaction chain.

Inter-frequency and inter-RAT measurements usually require measurement gaps, depending on user equipment capability. Even if gaps are not required based on user equipment capability, non-gap assisted measurements can introduce interruptions in a user equipment's connection. Furthermore, they may require extra power consumption at the user equipment to power up or down a separate reaction chain or have more on-time to perform measurements and still have the same amount of UL/DL traffic. From both the user equipment and network point of view, it is desirable to reduce the number of inter-frequency and inter-RAT measurements as much as possible.

Inter-frequency or inter-RAT measurements for mobility are needed if serving cell condition degraded or for load balancing. Both can be configured by a network node, for example, based on a A1/A2 report or may optionally be conditioned with S-measure. Based on the measurement results reported, the user equipment can be handed over to a cell with a carrier frequency supported by the user equipment as a single carrier. Neighboring cell measurements for CA/DC are needed if serving cell (group) cannot provide required bandwidth capacity. An SCell or PSCell can be added if its carrier frequency in combination with the carrier frequency of the current serving cell is supported by the UE and NW as CA/DC.

Conditions and reasons for when there is a need for neighboring cells'measurements differ and are different whether the measurements are for mobility or SCell/PSCell addition. A list of frequencies useful for mobility is different than a list of useful carriers for SCell/PSCell addition. A list of frequencies useful for mobility is different than a list of useful carriers for SCell/PSCell addition.

A measurement configuration contains measurement objects, reporting configurations, measurement identities, measurement quantity, and measurement gap configurations. However, it does not include the measurement purpose. Thus, the frequency carriers to measure cannot be tailored to the purpose unless the configuration is changed more dynamically by the network. A method is needed to help guide the user equipment measurements and the user equipment measurement burden based on the network motivation and need for requesting the user equipment to perform the measurements.

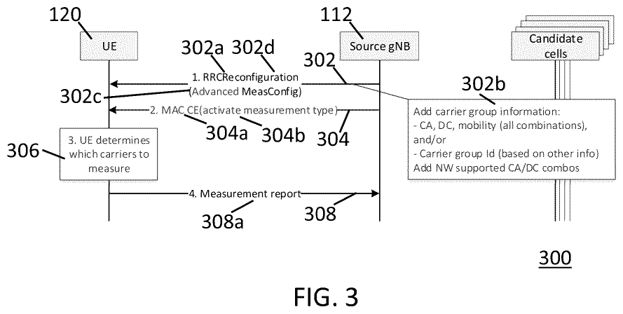

Turning now to FIG. 3, a signaling diagram 300 of example embodiments of the present disclosure is provided. The signaling diagram 300 illustrates an example method to optimize and reduce the number of inter-frequency and inter-RAT measurements at a user equipment without a need to change measurement configuration frequently or too often.

In one or more embodiments, at operation 302, the network node 112 transmits, to the user equipment 120, a configuration 302a. In some examples, the configuration 302a is a radio resource control reconfiguration message. In some examples, the configuration 302a defines a plurality of measurement types associated with carrier information 302b. In some examples, prior to transmission, the network determines additional useful information to add to the configuration 302a based on knowledge of user equipment 120 supported bands and band combinations (for example, as part of user equipment capabilities) combined with the networks own supported or preferred band combinations. In some examples, the configuration 302a includes an Advanced MeasConfig information element (IE) 302c.

In one example, separate carrier lists are provided in the configuration for mobility measurements and CA/DC measurements. CA and DC measurements may be provided in separate lists in some examples. In some examples, a carrier is configured on at least one list. Measurements for example carriers in mobility or CA, CA/DC list may be configured to be ON or OFF depending on need. Measurements may be controlled per carrier list type, for example, all carriers in one list type may be activated ON. In some examples, individual carriers within the list may be activated. In some examples, individual carriers across multiple lists may be activated. In some embodiments, measurements for the carriers in the mobility list may always be ON. For example, if a carrier is on both lists, it may always be measured. In some examples, one list may comprise both mobility and CA/DC carriers. Each example carrier in the configuration may be a mobility carrier, CA/DC carrier, or mobility and CA/DC carrier. These can be separated through an indication in a measurement object.

In some examples, as part of the radio resource control reconfiguration message for measurement configuration, determined additional information is added for example, to measurement objects. In some examples, the added information is CA information. In some examples, CA information groups the carriers in CA/DC band combinations as supported by the cell (and UE). In some examples, CA information indicates which carriers are intended for CA or DC. Indications of which carriers are intended for CA or DC may be realized in the same or different information elements. Other useful information may be added to group carriers based on other criteria.

In one or more embodiments, one or more carrier group identifiers are specified and each carrier belonging to one or more carrier groups are added to a measurement configuration. In some examples, a carrier grouping may be up to network node 112 implementation (non-disclosed location information or network preference based on capacity or other parameters). In some examples, information received at a network node 112 from one carrier in a group may be applicable to other carriers. In some examples, network node 112 may have different priority to use a carrier from the group as target for a serving cell or as added SCell or PSCell.

In some examples, further information related to how carriers in the same group should be treated is provided to user equipment 120. For example, carrier selection may be done based on network indication/configuration. In some examples, there is an indication from the network node 112 to measure only one carrier. In some examples, the information may consist of the network node 112 indicating an absolute position of a reference signal to measure. For instance, the network node 112 may indicate an absolute frequency to a reference point (e.g., to a center of the reference signal, ceil(LPRB_width/2)). In some examples, the network node 112 may indicate a relative position of a reference signal to measure. In some examples, the network node 112 may indicate a relative position to absolute radio frequency carrier number (ARFCN). In some examples, the network node 112 indicates a relative position from the start of the carrier bandwidth. In some examples, network node 112 indicates measurements on single carrier from a group of carriers is sufficient but leaves selection of the carrier to the user equipment.

In one or more embodiments, at operation 304, the network node 112 indicates one or more measurement types to a user equipment 120. In some examples, the indication 304 is a medium access control (MAC) control element (CE) message 304a. However, in other examples the indication may be a radio resource control (RRC) message or a Downlink Control Information (DCI) message. In some examples, the indication 304 activates one or more measurement types 304b. In other examples, the indication 304 indicates that the user equipment 120 should activate one or more measurement types 304b based on user preferences. In some examples, the user equipment 120 is indicated not to measure other carriers than those supported in a CA combination with its serving cell. In an alternative, the UE will autonomously match the CA/DC information to focus the measurement on one or more of the CA carriers which are supported by the UE and NW. In some examples, the group information may indicate the user equipment 120 to only measure and report one carrier per group. In some examples, group information may indicate to the user equipment 120 that acquisition of timing (detection) of other cells in the same group can be done efficiently based on detected cells in the selected carrier of the group.

In some examples, an indication of intended measurement type is included in each carrier configuration. For example, there may be an indication for each carrier/measurement object about the purpose of the measurement (e.g., CA or DC) and the carriers can be grouped. Measurements for CA/DC carriers may be turned ON/OFF (activated/deactivated) by the network. In some examples, a network decided indication 304a or reconfiguration indicate measurements to be ON/OFF or activated/deactivated based on measurement specific thresholds or a data buffer status (i.e., needed bandwidth for user equipment traffic). In some examples, an indication 304a may be a carrier or carrier group specific (e.g., grouped by type). In addition to turning measurements ON/OFF, the network node 112 may use this information to indicate to the user equipment 120 that it can relax measurements (i.e., measure less frequently) on some carrier/carrier group according to measurement type.

In some examples, the network node 112 configures and allows user equipment 120 autonomous selection of carriers to be measured. In some examples, the network node 112 adds conditions for user equipment valuation.

In one or more embodiments, at operation 306, the user equipment 120 determines which carriers to measure. In some examples, the user equipment 120 reduces the number of measurements with the same configuration by performing more intelligent and targeted measurements with less effort. In some examples, the user equipment executes one or more measurements based on one or more measurement types and one or more carriers indicated by the network node or chosen based on user equipment preferences.

In one or more embodiments, at operation 308, the user equipment 120 transmits, to the network node 112, a measurement report 308a. In some examples, the measurement report 308a includes one or more measurements executed based on one or more measurement types and/or one or more carriers indicated by the network node or chosen based on user equipment preferences. The report 308a may be transmitted upon an event or periodically.

In some examples, as described above with respect to operations 306-308, the user equipment 120 utilizes information to evaluate which measurements among the configured measurement objects should be performed at a given time and transmits a measurement report when a reporting event is met or periodically. In some examples, mobility carriers and mobility+CA/DC carriers may be configured to be always measured. In some examples, mobility carriers may be configured to be always measured. In some examples with CA/DC, carrier measurements can be ON/OFF based on the network configuration, activation/deactivation, or associated threshold. In some examples, there is an indication for each carrier/measurement object about the purpose of the measurement (e.g., CA or DC) and the carriers can be grouped according to CA/DC combinations supported by the user equipment 120 with the current serving cell. In some examples, the network node 112 configures the user equipment 120 to activate/deactivate measurements on a carrier or group of carriers. In some examples, user equipment 120 is configured to activate a specific measurement and reporting configuration based on its UL and/or DL buffer status. In some examples, this is achieved by making a measID activate-able. In some examples, the user equipment 120 is configured with report triggers that include SCell activation/deactivation and buffer status reports. In some examples, a measurement report may trigger activation/deactivation of a measurement. In some examples, advantages are provided in that less signaling and faster reporting is achieved compared to legacy procedure where the user equipment first sends a buffer status report, followed by a network activating or configuring measurement.

In some examples, the user equipment 120 utilizes information to evaluate which measurements among configured measurement objects should be performed and transmits measurement report when a reporting event is met or periodically. In some examples, user equipment 120 follows the network node 112 specified carrier to measure preferred reference signal may be specified in every carrier group. In some examples, the preferred reference signal may have an indication in the reference signal itself. In examples with user equipment autonomous selection of the carrier, the user equipment 120 may select to measure one carrier in the group based on selecting at least one reference signal to measure, provided that (i) the reference signal within the carrier list is configured, (ii) the user equipment 120 has measured each reference signal for at least one measurement period, and the RSRP difference between reference signals is within a particular dB, and (iii) the user equipment is in good radio conditions. In some examples, the user equipment 120 has more flexibility to organize its measurements for those situations where, for example, cells are located. In some examples, a measID is created that references several measurement objects. The measID's report configuration indicates via a flag or implied by the presence of a measObjectIDList in the measIDToAddMod that a report can refer to one of the i, and it is left to the user equipment 120 which measurement object to use. The report event triggers may be scaled independently according to frequency. In some examples, the measurements can be reused directly. In some examples, procedure delays are reduced.

In some examples, user equipment 120 receives an enhanced measurement configuration with further information as part of a group of carrier frequencies or cells on each configured measurement. In some examples, the user equipment is in a radio resource control connected mode and receives a radio resource control reconfiguration with measurement configuration from its serving cell. In some examples, the received measurement configuration may include information on whether a measurement object is for mobility, CA, DC, or any combination of these. In some examples, the received measurement configuration may include information on whether two or more measurement objects belong to the same group. In some examples, the received measurement configuration may include information on whether measurement and corresponding reporting configuration of a carrier in the same group (e.g., mobility, CA, DC, other, or a combination) should await activation/deactivation triggered by the network node (e.g., via the MAC CE). In some examples, the received measurement configuration may include information on whether measurement and a corresponding reporting configuration of a carrier in the same group (e.g., mobility, CA, DC, other, or a combination) should be activated/deactivated based on conditions provided by the network node 112. Non-limiting examples of such conditions may include (i) activate measurement on all carriers in a mobility group when A2 measurement reporting is triggered (A2: RSRP/RSRQ measured on serving becomes worse than threshold), (ii) activate measurements on carriers in a CA group when A4 measurement reporting event is triggered (A4: neighbor becomes better than a threshold), (iii) activate measurements on carriers in a DC group, or (iv) activate measurements on carriers in an another group. In some examples, the user equipment only measures and reports one carrier from the carriers in a group.

In some examples, the network node 112 further indicates which carrier from the group of carriers in a group should be measured. In some examples, the network node 112 may further indicate which carrier from the group of carriers in a group should be measured based on given conditions. In some examples, the network node may indicate that which carrier from the group of carriers in a group should be measured is left up to user equipment implementation. The user equipment 120 may select a carrier for which the user equipment 120 does not need measurement gaps. The user equipment 120 may select a carrier for which the user equipment 120 has lowest power consumption. The user equipment 120 may select the carrier which does not require retuning of the radio frequency carrier. The user equipment may select the carrier for which the user equipment has the lowest power consumption. The user equipment may select the carrier which does not require retuning of the radio frequency carrier. The user equipment may select the carrier which is closest to the carrier of one of the currently serving cells, which may have a benefit of potentially only adjusting the bandwidth of the reception. The user equipment may select the carrier which has the largest coverage according to carrier frequency, which may have a benefit of reliability to obtain a measurement. The user equipment may select the carrier which has the smallest coverage according to carrier frequency, which may have a benefit of obtaining a lower limit for radio link quality.

Turning now to FIG. 4, an example flowchart is illustrated for a process 400 performed by an apparatus embodied by, associated with or otherwise in communication with (hereinafter generally referenced as being embodied by) a user equipment (120) in order to transmit a measurement report based on network preferences.

As shown in block 402 of FIG. 4, the apparatus embodied by the user equipment (120) includes means, such as the processor (12), the radio interface (16), the user interface (18), and/or the like, for receiving (302), from a network node (112), a configuration (302a) defining a plurality of measurement types associated with carrier information (302b) that corresponds to one or more carriers and an indication (304) from the network node (112) to indicate which of the one or more carriers that corresponds to the one or more measurement types of the plurality of measurement types are to be measured. In some examples, the configuration (302a) comprises a radio resource control (RRC) reconfiguration (302d) message. In some examples, the plurality of measurement types comprise at least one of: carrier aggregation (CA) information, dual connectivity (DC) information, mobility information, dedicated carrier information (302b), carrier group information, network supported or preferred combinations of carrier aggregation and dual connectivity, or measurement conditions. In some examples, the plurality of measurement types is for at least of a single carrier or a group of carriers. In some examples, the plurality of measurement types is in a list form.

As shown in block 404 of FIG. 4, the apparatus embodied by the user equipment (120) includes means, such as the processor (12), the radio interface (16), the user interface (18), and/or the like, for executing measurements on the one or more carriers that corresponds to the one or more measurement types of the plurality of measurement types, according to the received indication (304). In some examples, the received indication is comprised in one of: a DCI (Downlink Control Information) message, a medium access control (MAC) control element (CE) message (304a) or a radio resource control (RRC) message. In some examples, the indication activates the one or more measurement types (304b) based on at least one of a measurement type specific threshold, a buffer status report (BSR), or a bandwidth (BW) requirement for the user equipment (120). In some examples, the one or more measurement types are activated (304b) for at least one of a single carrier or a group of carriers. In some examples, the RRC reconfiguration (302a) message comprises a MeasConfig information element (IE) (302c) defining the plurality of measurement types.

As shown in block 406 of FIG. 4, the apparatus embodied by the user equipment (120) includes means, such as the processor (12), the radio interface (16), the user interface (18), and/or the like, for transmitting (308), to the network node (112), a measurement report (308a) comprising measurement results of the one or more measurements performed based on the one or more measurement types.

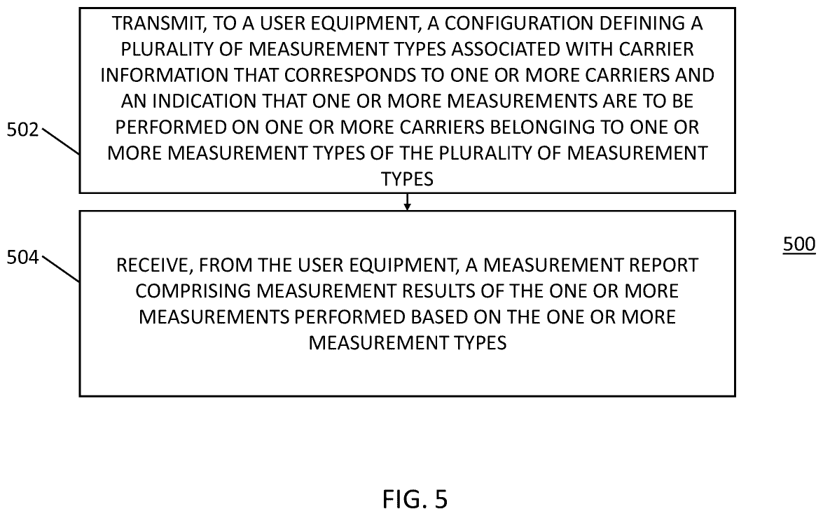

Turning now to FIG. 5, an example flowchart is illustrated for a process 500 performed by an apparatus embodied by, associated with or otherwise in communication with (hereinafter generally referenced as being embodied by) a network node (112) in order to receive a measurement report based on network preferences.

As shown in block 502 of FIG. 5, the apparatus embodied by the network node (112) includes means, such as the processor (12), the radio interface (16), the user interface (18), and/or the like, for transmitting (302), to a user equipment (120), a configuration (302a) defining a plurality of measurement types associated with carrier information (302b) that corresponds to one or more carriers and an indication (304) to indicate to the user equipment (120) which of the one or more carriers that corresponds to one or more measurement types of the plurality of measurement types are to be performed on the user. In one or more embodiments, the indication is comprised in one of: a DCI (Downlink Control Information) message, a medium access control (MAC) control element (CE) message (304a) or a radio resource control (RRC) message. In some examples, the indication activates the one or more measurement types (304b) based on at least one of a measurement type specific threshold, a buffer status report (BSR), or a bandwidth (BW) requirement for the user equipment (120). In some examples, the configuration (302a) comprises a radio resource control (RRC) reconfiguration (302d) message. In some examples, the one or more measurement types are activated (304b) for at least one of a single carrier or a group of carriers. In some examples, the RRC reconfiguration (302a) message comprises a MeasConfig information element (IE) (302c) defining the plurality of measurement types. In some examples, the plurality of measurement types comprise at least one of: carrier aggregation information, dual connectivity information, mobility information, dedicated carrier information (302b), carrier group information, network supported or preferred combinations of carrier aggregation and dual connectivity, or measurement conditions. In some examples, the plurality of measurement types is for at least of a single carrier or a group of carriers. In some examples, the plurality of measurement types is in a list form.

As shown in block 504 of FIG. 5, the apparatus embodied by the network node (112) includes means, such as the processor (12), the radio interface (16), the user interface (18), and/or the like, for receiving (308), from the user equipment (120), a measurement report (308a) comprising measurement results of the one or more measurements performed based on the one or more measurement types.

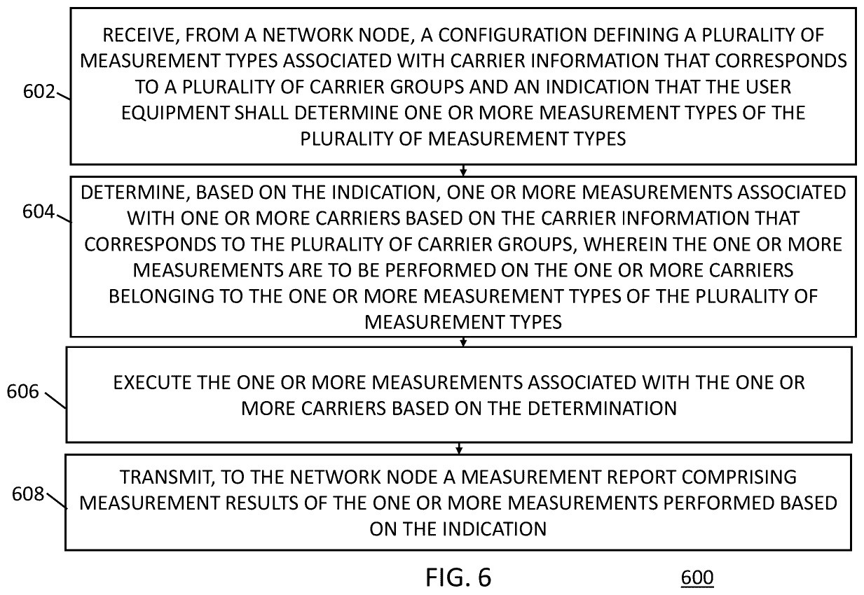

Turning now to FIG. 6, an example flowchart is illustrated for a process 600 performed by an apparatus embodied by, associated with or otherwise in communication with (hereinafter generally referenced as being embodied by) a user equipment (120) in order to transmit a measurement report based on an indication that the user equipment should determine one or more measurements.

As shown in block 602 of FIG. 6, the apparatus embodied by the user equipment (120) includes means, such as the processor (12), the radio interface (16), the user interface (18), and/or the like, for receiving (302), from a network node (112), a configuration (302a) defining a plurality of measurement types associated with carrier information (302b) that corresponds to a plurality of carrier groups and an indication (304) that the user equipment (120) shall determine one or more measurement types of the plurality of measurement types. In some examples, the configuration (302a) comprises a radio resource control (RRC) reconfiguration (302d) message. In some examples, the RRC reconfiguration (302a) message comprises a MeasConfig information element (IE) (302c) defining the plurality of measurement types. In some examples, the plurality of measurement types comprise at least one of: carrier aggregation information, dual connectivity information, mobility information, dedicated carrier information (302b), carrier group information, network supported or preferred combinations of carrier aggregation and dual connectivity, or measurement conditions. In some examples, the plurality of measurement types is for at least of a single carrier or a group of carriers. In some examples, the plurality of measurement types is in a list form.

As shown in block 604 of FIG. 6, the apparatus embodied by the user equipment (120) includes means, such as the processor (12), the radio interface (16), the user interface (18), and/or the like, for determining (306), based on the indication (304), one or more measurements associated with one or more carriers based on the carrier information (302b) that corresponds to the plurality of carrier groups, wherein the one or more measurements are to be performed on the one or more carriers belonging to the one or more measurement types of the plurality of measurement types. In some examples, the indication (304) comprises one of: a medium access control (MAC) control element (CE) message (304a) or a radio resource control (RRC) message or a Downlink Control Information (DCI) message. In some examples, the one or more carriers are determined (306) based on at least one of network conditions or user equipment (120) preferences.

As shown in block 606 of FIG. 6, the apparatus embodied by the user equipment (120) includes means, such as the processor (12), the radio interface (16), the user interface (18), and/or the like, for executing the one or more measurements associated with the one or more carriers based on the determination.

As shown in block 608 of FIG. 6, the apparatus embodied by the user equipment (120) includes means, such as the processor (12), the radio interface (16), the user interface (18), and/or the like, for transmitting, to the network node a measurement report (308a) comprising measurement results of the one or more measurements performed based on the indication.

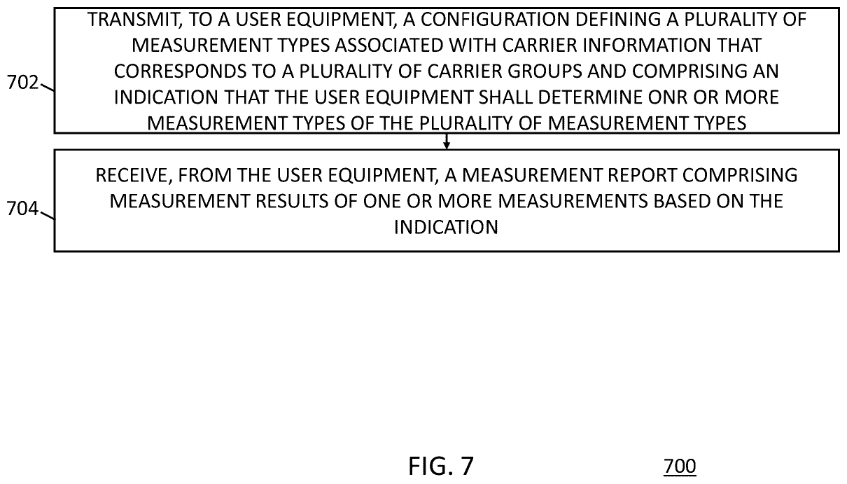

Turning now to FIG. 7, an example flowchart is illustrated for a process 700 performed by an apparatus embodied by, associated with or otherwise in communication with (hereinafter generally referenced as being embodied by) a network node (112) in order to receive a measurement report based on user equipment preferences.

As shown in block 702 of FIG. 7, the apparatus embodied by the network node (112) includes means, such as the processor (12), the radio interface (16), the user interface (18), and/or the like, for transmitting (302), to a user equipment (120), a configuration (302a) defining a plurality of measurement types associated with carrier information (302b) that corresponds to a plurality of carrier groups and an indication (304) that the user equipment (120) shall determine (306) one or more measurement types of the plurality of measurement types. In some examples, the indication comprises one of: a medium access control (MAC) control element (CE) message (304a) or a radio resource control (RRC) message or a Downlink Control Information (DCI) message. In some examples, the configuration (302a) comprises a radio resource control (RRC) reconfiguration (302d) message. In some examples, the RRC reconfiguration (302a) message comprises a MeasConfig information element (IE) (302c) defining the plurality of measurement types. In some examples, the plurality of measurement types comprise at least one of: carrier aggregation information, dual connectivity information, mobility information, dedicated carrier information (302b), carrier group information, network supported or preferred combinations of carrier aggregation and dual connectivity, or measurement conditions. In some examples, the plurality of measurement types is for at least of a single carrier or a group of carriers. In some examples, the plurality of measurement types is in a list form. In some examples, the one or more carriers are determined (306) based on at least one of network conditions or user equipment (120) preferences. In some examples, the one or more carriers are determined (306) based on at least one of network conditions or user equipment (120) preferences.

As shown in block 704 of FIG. 7, the apparatus embodied by the network node (112) includes means, such as the processor (12), the radio interface (16), the user interface (18), and/or the like, for receiving (308), from the user equipment (120), a measurement report (308a) comprising measurement results of one or more measurements performed based on the indication.

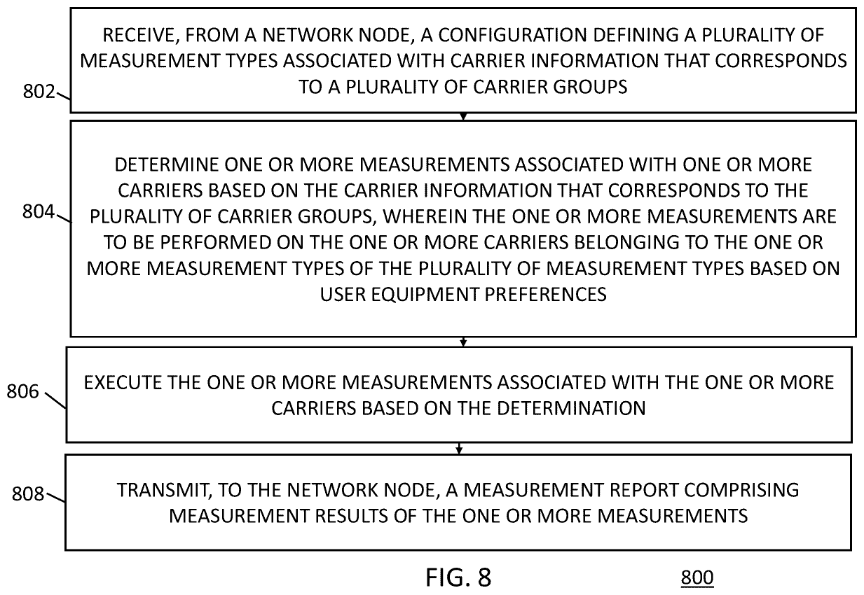

Turning now to FIG. 8, an example flowchart is illustrated for a process 800 performed by an apparatus embodied by, associated with or otherwise in communication with (hereinafter generally referenced as being embodied by) a user equipment (120) in order to transmit a measurement report based on user equipment preferences.

As shown in block 802 of FIG. 7, the apparatus embodied by the user equipment (120) includes means, such as the processor (12), the radio interface (16), the user interface (18), and/or the like, for receiving (302), from a network node (112), a configuration (302a) defining a plurality of measurement types associated with carrier information (302b) that corresponds to a plurality of carrier groups.

As shown in block 804 of FIG. 7, the apparatus embodied by the user equipment (120) includes means, such as the processor (12), the radio interface (16), the user interface (18), and/or the like, for determining (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. In some examples, the user equipment (120) preferences comprise determining (306) the one or more carriers for which the user equipment (120) does not need measurement gaps. In some examples, the user equipment (120) preferences comprise determining (306) the one or more carriers for which the user equipment (120) has a lowest power consumption. In some examples, the user equipment (120) preferences comprise determining (306) the one or more carriers which do not require retuning of a radio frequency carrier. In some examples, the one or more carriers comprise a first carrier closest to a second carrier of a currently serving cell. In some examples, the user equipment (120) preferences comprise determining (306) the one or more carriers with a largest coverage of the carrier information (302b) according to carrier frequency. In some examples, the user equipment (120) preferences comprise determining (306) the one or more carriers with a smallest coverage of the carrier information (302b) according to carrier frequency.

As shown in block 806 of FIG. 8, the apparatus embodied by the user equipment (120) includes means, such as the processor (12), the radio interface (16), the user interface (18), and/or the like, for executing the one or more measurements associated with the one or more carriers based on the determination.

As shown in block 808 of FIG. 8, the apparatus embodied by the user equipment (120) includes means, such as the processor (12), the radio interface (16), the user interface (18), and/or the like, for transmitting (308), to the network node (112), a measurement report (308a) comprising measurement results of the one or more measurements.

FIGS. 4-8 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions 15 which embody the procedures described above may be stored by a memory 14 of an apparatus employing an embodiment and executed by a processor 12. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

In one or more embodiments, a user equipment (120) for wireless communication, is provided, including at least one processor and at least one memory storing instructions thereon that, when executed by the at least one processor, cause the user equipment (120) to receive (302), from a network node (112), a configuration (302a) defining a plurality of measurement types associated with carrier information (302b) that corresponds to a plurality of carrier groups. The user equipment (120) is further caused to determine (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The user equipment (120) is further caused to execute the one or more measurements associated with the one or more carriers based on the determination.

In one or more embodiments, the user equipment (120) is further caused to transmit (308), to the network node (112), a measurement report (308a) comprising measurement results of the one or more measurements.

In one or more embodiments, the user equipment (120) preferences comprise determining (306) the one or more carriers for which the user equipment (120) does not need measurement gaps.

In one or more embodiments, the user equipment (120) preferences comprise determining (306) the one or more carriers for which the user equipment (120) has a lowest power consumption.

In one or more embodiments, the user equipment (120) preferences comprise determining (306) the one or more carriers which do not require retuning of a radio frequency carrier.

In one or more embodiments, the one or more carriers comprise a first carrier closest to a second carrier of a currently serving cell.

In one or more embodiments, the user equipment (120) preferences comprise determining (306) the one or more carriers with a largest coverage of the carrier information (302b) according to carrier frequency.

In one or more embodiments, the user equipment (120) preferences comprise determining (306) the one or more carriers with a smallest coverage of the carrier information (302b) according to carrier frequency.

In one or more embodiments, a user equipment (120) is provided for wireless communication, including means for receiving (302), from a network node (112), a configuration (302a) defining a plurality of measurement types associated with carrier information (302b) that corresponds to a plurality of carrier groups. The user equipment (120) further includes means for determining (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The user equipment (120) further includes means for executing the one or more measurements associated with the one or more carriers based on the determination.

In one or more embodiments, a computer-implemented method, performed by a user equipment (120), is provided, including receiving (302), from a network node (112), a configuration (302a) defining a plurality of measurement types associated with carrier information (302b) that corresponds to a plurality of carrier groups. The method further includes determining (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The method further includes executing the one or more measurements associated with the one or more carriers based on the determination.

In one or more embodiments, a non-transitory computer readable storage medium is provided including computer instructions that, when executed by a user equipment, cause the user equipment to receive (302), from a network node (112), a configuration (302a) defining a plurality of measurement types associated with carrier information (302b) that corresponds to a plurality of carrier groups. The user equipment (120) is further caused to determine (306) one or more measurements associated with one or more carriers based on the carrier information (302b) that corresponds to the plurality of carrier groups, wherein the one or more measurements are to be performed on the one or more carriers belonging to the one or more measurement types of the plurality of measurement types based on user equipment (120) preferences. The user equipment (120) is further caused to execute the one or more measurements associated with the one or more carriers based on the determination.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

What is claimed is:

1. A user equipment for wireless communication, comprising:
at least one processor; and
at least one memory storing instructions thereon that, when executed by the at least one processor, cause the user equipment to:
receive, from a network node, a configuration defining a plurality of measurement types associated with carrier information that corresponds to a plurality of carrier groups;
determine one or more measurements associated with one or more carriers based on the carrier information that corresponds to the plurality of carrier groups, wherein the one or more measurements are to be performed on the one or more carriers belonging to the one or more measurement types of the plurality of measurement types based on user equipment preferences; and
execute the one or more measurements associated with the one or more carriers based on the determination.

2. The user equipment of claim 1, further caused to transmit, to the network node, a measurement report comprising measurement results of the one or more measurements.

3. The user equipment of claim 1, wherein the user equipment preferences comprise determining the one or more carriers for which the user equipment does not need measurement gaps.

4. The user equipment of claim 1, wherein the user equipment preferences comprise determining the one or more carriers for which the user equipment has a lowest power consumption.

5. The user equipment of claim 1, wherein the user equipment preferences comprise determining the one or more carriers which do not require retuning of a radio frequency carrier.

6. The user equipment of claim 5, wherein the one or more carriers comprise a first carrier closest to a second carrier of a currently serving cell.

7. The user equipment of claim 1, wherein the user equipment preferences comprise determining the one or more carriers with a largest coverage of the carrier information according to carrier frequency.

8. The user equipment of claim 1, wherein the user equipment preferences comprise determining the one or more carriers with a smallest coverage of the carrier information according to carrier frequency.

9. A user equipment for wireless communication, comprising:
means for receiving, from a network node, a configuration defining a plurality of measurement types associated with carrier information that corresponds to a plurality of carrier groups;
means for determining one or more measurements associated with one or more carriers based on the carrier information that corresponds to the plurality of carrier groups, wherein the one or more measurements are to be performed on the one or more carriers belonging to the one or more measurement types of the plurality of measurement types based on user equipment preferences; and
means for executing the one or more measurements associated with the one or more carriers based on the determination.

10. A computer-implemented method, performed by a user equipment, comprising:
receiving, from a network node, a configuration defining a plurality of measurement types associated with carrier information that corresponds to a plurality of carrier groups;
determining one or more measurements associated with one or more carriers based on the carrier information that corresponds to the plurality of carrier groups, wherein the one or more measurements are to be performed on the one or more carriers belonging to the one or more measurement types of the plurality of measurement types based on user equipment preferences; and
executing the one or more measurements associated with the one or more carriers based on the determination.

11. A non-transitory computer readable storage medium including computer instructions that, when executed by a user equipment, cause the user equipment to:
receive, from a network node, a configuration defining a plurality of measurement types associated with carrier information that corresponds to a plurality of carrier groups;
determine one or more measurements associated with one or more carriers based on the carrier information that corresponds to the plurality of carrier groups, wherein the one or more measurements are to be performed on the one or more carriers belonging to the one or more measurement types of the plurality of measurement types based on user equipment preferences; and
execute the one or more measurements associated with the one or more carriers based on the determination.
